(19) United States
(12) Patent Application Publication
(10) Pub. No.: US 2019/0120460 A1
(43) Pub. Date: Apr. 25, 2019

(54) HORTICULTURAL LED ILLUMINATOR

(71) Applicant: David Gerard Pelka, Los Angeles, CA (US)

(72) Inventor: David Gerard Pelka, Los Angeles, CA (US)

(21) Appl. No.: 16/163,007

(22) Filed: Oct. 17, 2018

Related U.S. Application Data
(60) Provisional application No. 62/575,992, filed on Oct. 23, 2017.

(51) Int. Cl. F21V 5/04; A01G 7/04

(52) U.S. Cl. CPC F21V 5/04; F21Y 2115/10; A01G 7/045

(57) ABSTRACT

A lamp includes a plurality of light sources arranged in a planar array, each light source having a light-emitting diode (LED) and an optical element. The optical element includes a substantially transparent first portion having a first refractive index, the first portion configured to receive light from the LED. The optical element further includes a substantially transparent second portion having a second refractive index greater than the first refractive index, the second portion having an emission surface with a two-lobed shape.

### RELATED APPLICATIONS

This application claims the benefit of priority to U.S. Provisional Appl. No. 62/575,992 filed Oct. 23, 2017, which is incorporated in its entirety by reference herein.

### BACKGROUND

### Field

The present application is generally directed to systems and methods of providing light, and more specifically, to horticultural light-emitting illuminators.

### Description of the Related Art

Various types of artificial light sources (e.g., lamps; “grow lights”) have previously been used in horticulture. For example, incandescent lamps, fluorescent lamps, high intensity discharge (HID) lamps, metal halide lamps, high-pressure sodium (HPS) lamps, and solid-state (e.g., light-emitting diode or LED) lamps. Horticultural lamps are generally designed to facilitate photosynthesis by the plants being grown (e.g., edible, medicinal, recreational, and/or ornamental plants and fungi) with spectral distributions of light selected to mimic sunlight or to approximate an optimal spectral distribution for growth of the particular plants being grown.

### SUMMARY

Certain embodiments described herein provide a lamp comprising a plurality of light sources arranged in a planar array, each light source comprising a light-emitting diode (LED) and an optical element. The optical element comprises a substantially transparent first portion having a first refractive index, the first portion configured to receive light from the LED. The optical element further comprises a substantially transparent second portion having a second refractive index greater than the first refractive index, the second portion having an emission surface with a two-lobed shape.

Certain embodiments described herein provide a lamp comprising a plurality of light sources arranged in a planar array, each light source comprising a light-emitting diode (LED) and an optical element and having an offset parallel to the planar array.

The offset is between a center of the LED and a center of the optical element. The offsets in a first region of the planar array are different from the offsets in a second region of the planar array.

Certain embodiments described herein provide a method of fabricating a lamp. The method comprises arranging a plurality of light sources in a planar array, each light source comprising an optical element and a light-emitting diode (LED). The method further comprises positioning the optical elements and the LEDs of the plurality of light sources relative to one another such that light emitted by the LEDs and received by the optical elements is emitted by the optical elements to irradiate a planar region spaced from the planar array by at least 300 millimeters and having dimensions of at least 1200 millimeters by at least 600 millimeters, the planar region irradiated with an illuminance that is substantially uniform.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A schematically illustrates an example lamp in accordance with certain embodiments described herein.

FIG. 1B schematically illustrates a view of the example lamp of FIG. 1A from the planar region along the illumination direction in accordance with certain embodiments described herein.

FIGS. 2A-2D schematically illustrate various views of example light sources in accordance with certain embodiments described herein.

FIG. 3A schematically illustrates a front side of the plurality of optical elements of an example plurality of light sources in accordance with certain embodiments described herein.

FIG. 3B schematically illustrates a back side of the plurality of optical elements of the plurality of light sources of FIG. 3A in accordance with certain embodiments described herein.

FIG. 3C shows the x- and y-coordinates (in millimeters) of the LEDs for an example plurality of light sources in accordance with certain embodiments described herein.

FIG. 4A illustrates an example illuminance across a planar region calculated for the example light source of FIGS. 2A-2B in accordance with certain embodiments described herein.

FIG. 4B illustrates an example illuminance across a planar region calculated for the example light source of FIGS. 2C-2D in accordance with certain embodiments described herein.

FIG. 5 illustrates an example illuminance across a planar region calculated for the example lamp of FIGS. 1A and 1B using the example light source of FIGS. 2A-2B and with a distance of 300 millimeters between the lamp and the planar region in accordance with certain embodiments described herein.

FIG. 6A illustrates an example illuminance across the planar region calculated for the example lamp of FIG. 3A using the example light source of FIGS. 2C and 2D with uniformly spaced LEDs and a distance of 300 millimeters between the lamp and the planar region.

FIG. 6B illustrates an example illuminance across the planar region calculated for the example lamp of FIGS. 3A and 3B using the example light source of FIGS. 2C and 2D with non-uniformly spaced LEDs and a distance of 300 millimeters between the lamp and the planar region in accordance with certain embodiments described herein.

FIGS. 7A-7H illustrate various example lamp configuration using single-lobe light sources in accordance with certain embodiments described herein.

FIG. 8 is a flow diagram of an example method of fabricating a lamp in accordance with certain embodiments described herein.

### DETAILED DESCRIPTION

Certain embodiments described herein provide a lamp comprising a plurality of light sources, with each light source of the plurality of light sources configured to direct light towards a planar region spaced from the lamp (e.g., by at least 300 millimeters) along an illumination direction. The planar region has a first linear dimension in a first direction substantially perpendicular to the illumination direction and has a second linear dimension in a second direction substantially perpendicular to the illumination direction and substantially perpendicular to the first direction. For example, the first and second linear dimensions can comprise one of the following: at least 1200 millimeters and at least 600 millimeters, at least 600 millimeters and at least 600 millimeters, at least 1000 millimeters and at least 400 millimeters, at least 4 feet and at least 2 feet, and at least 2 feet and at least 2 feet. The light from the plurality of light sources illuminates the planar region with a substantially uniform illuminance (e.g., total luminous flux incident on a surface per unit area; expressed in units of lux or lumens per square meter). For example, an average illuminance across the planar region can be in a range of 25,000 lux to 50,000 lux and can be substantially uniform across the planar region.

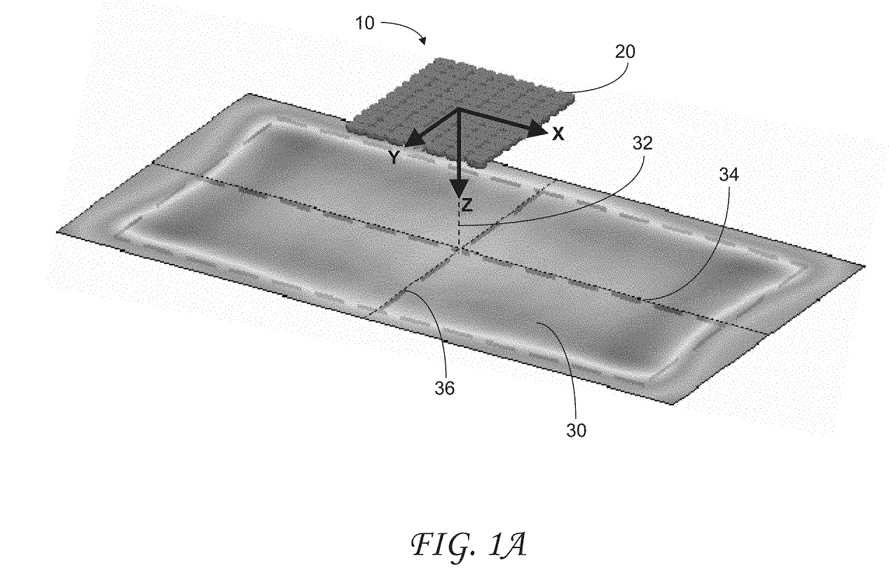

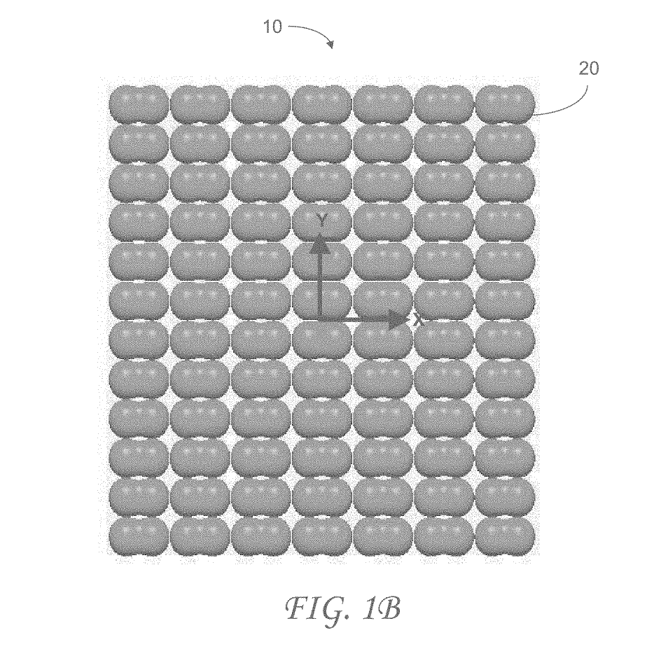

FIG. 1A schematically illustrates an example lamp 10 in accordance with certain embodiments described herein. The lamp 10 comprises a plurality of light sources 20, with each light source 20 of the plurality of light sources 20 configured to direct light towards a planar region 30 spaced from the lamp 10 (e.g., by at least 300 millimeters) along an illumination direction 32. The planar region 30 has a first linear dimension (e.g., at least 1200 millimeters) in a first direction 34 substantially perpendicular to the illumination direction 32 and has a second linear dimension (e.g., at least 600 millimeters) in a second direction 36 substantially perpendicular to the illumination direction 32 and substantially perpendicular to the first direction 34. The light from the plurality of light sources 20 illuminates the planar region 30 with a substantially uniform illuminance (e.g., total luminous flux incident on a surface per unit area; expressed in units of lux or lumens per square meter). For example, an average illuminance across the planar region 30 can be in a range of 25,000 lux to 45,000 lux and can be substantially uniform across the planar region 30.

For example, in certain embodiments, uniformity of the illuminance can be quantified using various formulas, including but not limited to, the minimum illuminance across the planar region 30 divided by the maximum illuminance across the planar region 30 (e.g., Iₘᵢₙ/Iₘₐₓ), the minimum illuminance across the planar region 30 divided by the average illuminance across the planar region 30 (e.g., Iₘᵢₙ/Iₐᵥₑ), or as some other formula (e.g., 2*Iₘᵢₙ/[Iₘₐₓ+Iₘᵢₙ]). As used herein, the term “substantially uniform” has its broadest reasonable interpretation, including, but not limited to a uniformity in a range greater than 60%, between 60% and 95%, between 60% and 90%, or between 70% and 90% (e.g., 88%). The lamp 10 of certain embodiments can advantageously be used in horticultural applications where a substantially uniform illuminance is to be delivered to plants in the planar region 30.

In certain embodiments, by virtue of each light source 20 being configured to illuminate the entire planar region 30 (e.g., having dimensions of 1200 millimeters by 600 millimeters and when positioned 300 millimeters from the planar region 30), the spectral distribution of the lamp 10 at the planar region 30 is the spectral distributions of the sum (e.g., superposition) of the light from the individual light sources 20. Certain such embodiments advantageously allow the spectral distribution of the lamp 10 at the planar region 30 to be easily modified (e.g., to account for or to mimic seasonal changes that occur in the spectral distribution of sunlight; to provide a spectral distribution that facilitates a predetermined chemical process within the plants irradiated by the lamp 10) by selecting the various LEDs 22 of the lamp 10 such that the sum (e.g., superposition) of the light from the individual light sources 20 provides the desired predetermined spectral distribution. For example, to modify a spectral distribution of the lamp 10 across the planar region 30 from a first spectral distribution to a second spectral distribution that is more heavily weighted towards the far-red portion of the spectrum (e.g., wavelengths in a range between 700 nanometers and 800 nanometers), a selected number of the various LEDs 22 of the lamp 10 that do not emit light in the far-red portion of the spectrum can be replaced with LEDs 22 that do emit light in the far-red portion of the spectrum. For another example, to modify a spectral distribution of the lamp 10 across the planar region 30 from a first spectral distribution to a second spectral distribution that is more heavily weighted towards the UVA portion of the spectrum (e.g., wavelengths in a range between 315 nanometers and 400 nanometers) and/or towards the UVB portion of the spectrum (e.g., wavelengths in a range between 280 nanometers and 315 nanometers), a selected number of the various LEDs 22 of the lamp 10 that do not emit light in the UVA and/or UVB portion of the spectrum can be replaced with LEDs 22 that do emit light in the UVA and/or UVB portion of the spectrum. For another example, a predetermined spectral distribution of the lamp 10 across the planar region 30 can be provided by judicious selection of the colors of the various LEDs 22 of the lamp 10.

In certain embodiments, by virtue of each light source 20 being configured to illuminate the entire planar region 30, the lamp 10 can provide an advantageous redundancy by which a sufficient flux with sufficient uniformity across the planar region 30 is still provided by the lamp 10 despite a loss of a small number of light sources 20 (e.g., five or fewer of the LEDs 22 becoming inoperative).

FIG. 1B schematically illustrates a view of the example lamp 10 of FIG. 1A from the planar region 30 along the illumination direction 32 in accordance with certain embodiments described herein. In certain embodiments, as schematically illustrated in FIGS. 1A and 1B, the plurality of light sources 20 of the example lamp 10 are arranged in a substantially planar (e.g., two-dimensional) array with a regular pattern. For example, the planar array of light sources 20 of FIGS. 1A and 1B are arranged in a substantially rectilinear pattern having an X-direction and a Y-direction substantially perpendicular to one another and having an illumination direction 32 that is along a Z-direction that is substantially perpendicular to both the X-direction and the Y-direction of the array. For example, the array can be about 314 millimeters along the X-direction and about 345 millimeters along the Y-direction. As schematically illustrated by FIG. 1A, in certain embodiments, the first direction 34 of the planar region 30 is substantially parallel to the X-direction of the array, the second direction 36 of the planar region 30 is substantially parallel to the Y-direction of the array, and the illumination direction 32 is substantially perpendicular to the planar region 30.

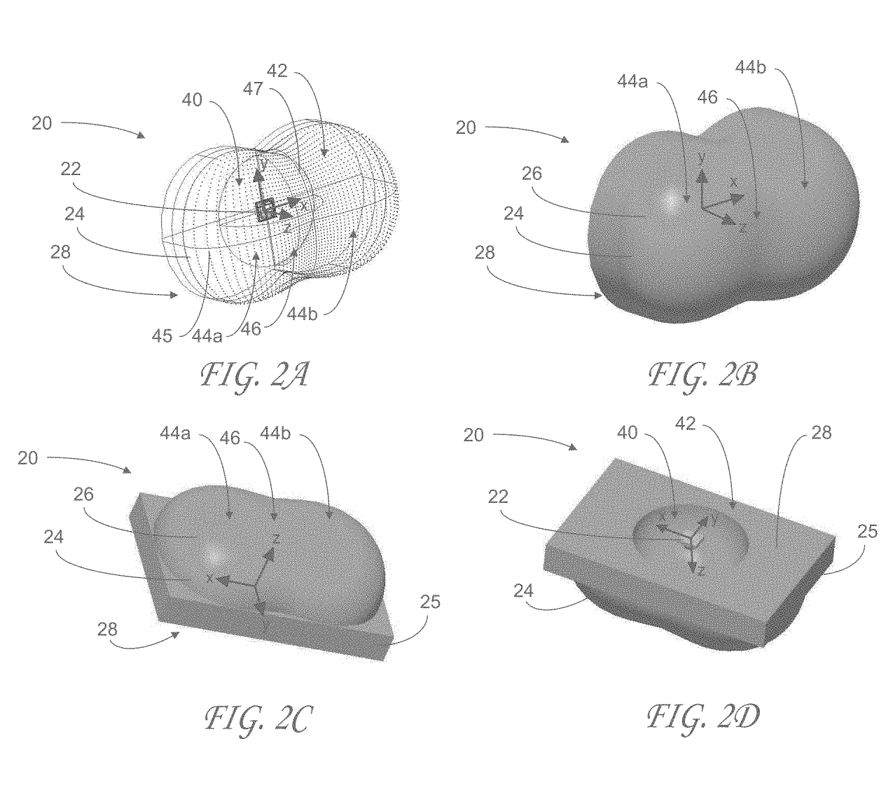

FIGS. 2A-2D schematically illustrate various views of example light sources 20 in accordance with certain embodiments described herein. Each of the light sources 20 of FIGS. 2A-2D can be configured to illuminate the entire planar region 30 (e.g., having dimensions of 1200 mm by 600 mm) when positioned 300 millimeters from the planar region 30. In certain embodiments, the plurality of light sources 20 comprises a plurality of light-emitting diodes (LEDs) 22 and a plurality of optical elements (e.g., lenses) 24 (e.g., each light source 20 comprising a LED 22 and an optical element 24).

FIG. 2A is a wireframe drawing of at least a portion of an example light source 20, and FIG. 2B is a solid surface drawing of a front side 26 of the optical element 24 of the at least a portion of the example light source 20 of FIG. 2A. FIG. 2C is a solid surface drawing of a front side 26 of the optical element 24 and the substrate 25 upon which the optical element 24 is molded of at least a portion of another example light source 20. FIG. 2D is a solid surface drawing of the back side 28 of the optical element 24 and the substrate 25 upon which the optical element 24 is molded of at least a portion of the example light source 20 of FIG. 2C.

Each LED 22 of the plurality of LEDs 22 can be configured to emit light having an emission spectrum and a spatial distribution that is substantially symmetric about an emission direction of the LED 22 (e.g., a direction substantially perpendicular to a surface of the LED 22). In certain embodiments, the plurality of LEDs 22 comprises one or more white LEDs (e.g., emitting light in a color temperature in a range of 5000 K to 6000 K) which can have predetermined operational parameters (e.g., a maximum current in a range of 500 mA to 3000 mA, a flux at current of 350 mA in a range of 100 lm to 300 lm, a maximum flux in a range of 200 lm to 1000 lm). Example LEDs compatible with certain such embodiments include, but are not limited to, XP-E, XP-E2, XP-G3, and XQ-E (high density), each available from Cree, Inc. of Durham, N.C. In certain embodiments, each of the light sources 20 of the lamp 10 comprises the same type of LED 22 (e.g., having substantially the same color spectrum as one another). In certain other embodiments, the various light sources 20 of the lamp 10 comprise two or more different types of LEDs 22 (e.g., having substantially different color spectra from one another) with the LEDs 22 selected to provide a predetermined color spectrum across the planar region 30.

In certain embodiments, each optical element 24 of the plurality of optical element 24 can comprise one or more refractive elements, one or more reflective elements, or both. In certain embodiments, each optical element 24 can comprise a “free-form” lens by which the optical element 24 does not have an axis of symmetry (e.g., as schematically illustrated by FIGS. 2A-2D). As schematically illustrated by FIGS. 2A and 2D, the optical element 24 can comprise a substantially transparent first portion 40 (e.g., at the back side 28 of the optical element 24) having a first refractive index, the first portion 40 configured to receive light from the LED 22, and a substantially transparent second portion 42 (e.g., at the front side 26 of the optical element 24) having a second refractive index greater than the first refractive index. The second portion 42 can be configured to emit the light received from one or more corresponding LEDs 22 toward the planar region 30. Light emitted from the corresponding one or more LEDs 22 can propagate through the first portion 40, refract at the interface between the first portion 40 and the second portion 42, propagate through the second portion 42, and refract at and be emitted from the interface between the second portion 42 and the surrounding material or environment (e.g., air). At least some of the light emitted from the second portion 42 of the lens 24 can propagate to the planar region 30. As used herein, the term “substantially transparent” has its broadest reasonable interpretation, including but not limited to, having a transmittance greater than 50%, greater than 70%, greater than 90%, greater than 95%, or greater than 99%.

For example, the first portion 40 can comprise a cavity containing gas (e.g., air) and having a first refractive index of 1, and the second portion 42 can comprise a substantially transparent solid material (e.g., PMMA; polycarbonate) having a second refractive index greater than 1. The example light source 20 of FIGS. 2A and 2B comprises an optical element 24 (e.g., a lens with a size of approximately 42 millimeters by 26 millimeters) having a first portion 40 comprising a cavity containing air and comprises a second portion 42 comprising PMMA. The example light source 20 of FIGS. 2C and 2D comprises an optical element 24 (e.g., a lens with a size of approximately 41.7 millimeters by 28.2 millimeters and a thickness of about 16.1 millimeters) having a first portion 40 comprising a cavity containing air and comprising a second portion 42 comprising polycarbonate. As schematically illustrated by FIGS. 2C and 2D, the optical element 24 can be molded on a substrate 25. For example, the substrate 25 can have a generally rectangular shape, as shown in FIGS. 2C and 2D, and can be used as a spacer to provide a predetermined spacing between adjacent optical elements 24 of the lamp 10. In certain embodiments, the substrate 25 has a thickness and comprises the back side 28 of the light source 20 at which the LED 22 is positioned, thereby providing a spacing between the front side 26 of the light source 20 and the back side 28 of the light source 20 such that the LED 22 has a predetermined position relative to the optical element 24 (e.g., relative to the first portion 40 and the second portion 42 of the optical element 24).

The first portion 40 can be positioned at or proximal to the back side 28 of the light source 20, and the at least one LED 22 can be positioned in or proximal to the first portion 40. For example, the LED 22 can be mounted on a printed circuit board positioned at the back side 28 and the emission surface (e.g., emission face) of the LED 22 can be positioned at the plane of the back side 28 or within the first portion 40 proximal to the plane of the back side 28. In certain embodiments, the first portion 40 has the shape of a segment of a sphere (e.g., a hemisphere; a segment defined by the intersection of a plane with a sphere, the plane not at a diameter of the sphere). For example, as schematically illustrated by FIGS. 2A and 2D, the first portion 40 has a shape defined by the intersection of a plane with a sphere, the plane not at a diameter of the sphere, and at least a portion of the at least one LED 22 is positioned within the plane (e.g., with the emission face of the LED 22 at the plane; with the emission face of the LED 22 within the first portion 40). Various other shapes of the first portion 40 and positions of the at least one LED 22 relative to the first portion 40 and to the second portion 42 are also compatible with certain embodiments disclosed herein.

In certain embodiments, the second portion 42 has an emission surface with a two-lobed shape, as schematically illustrated by FIGS. 2A-2D. For example, as schematically illustrated by FIG. 2A, the emission surface of the second portion 42 can have a first cross-section in a first plane (e.g., in a plane 45 that is substantially perpendicular to the plane of the back side 28 and/or that is substantially perpendicular to the emission face of the at least one LED 22, as shown in FIG. 2A), the first cross-section comprising two local maxima 44a, 44b and a local minimum 46 between the two local maxima 44a, 44b in the first plane. The emission surface of the second portion 42 can have a second cross-section in a second plane (e.g., in a plane 47 that is substantially perpendicular to the plane 45 and that is substantially perpendicular to the plane of the back side 28 and/or to the emission face of the at least one LED 22, as shown in FIG. 2A), the second cross-section comprising a single maximum. In certain embodiments, the emission surface of the second portion 42 is substantially symmetric about the plane 47, as schematically illustrated by FIGS. 2A-2D, such that the two lobes are substantially identical to one another. In certain other embodiments, the two lobes differ from one another (e.g., having a difference between the local maxima and the minimum; having different curvatures of the emission surface of the second portion 42). In certain embodiments, the emission surface of the second portion 42 is substantially symmetric about the plane 45, as schematically illustrated by FIGS. 2A-2D, such that the single maximum is centered on the plane 45. In certain embodiments, the first portion 40 and the second portion 42 are both centered on a center axis of the light source 20, the center axis substantially perpendicular to the plane of the back side 28 (e.g., the center axis extending along and substantially parallel to the illumination direction 32 of the lamp 10).

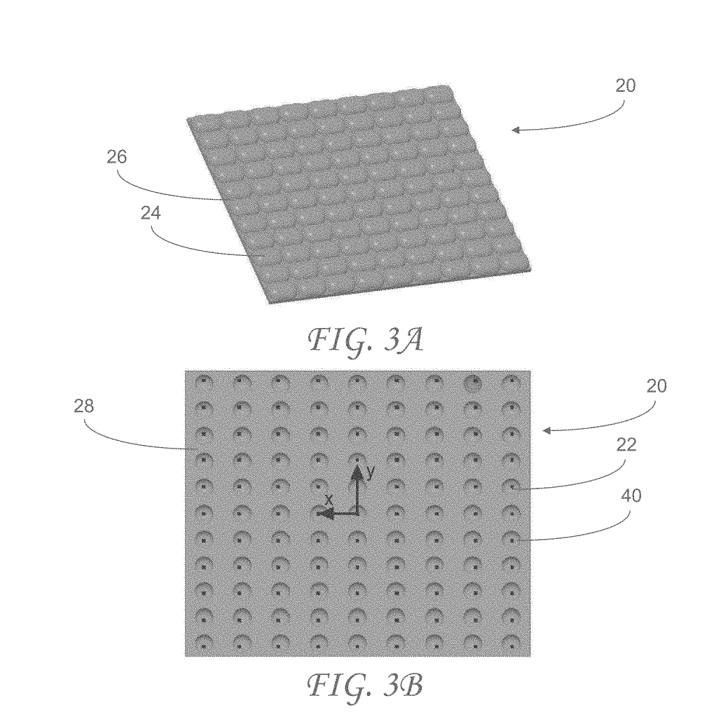

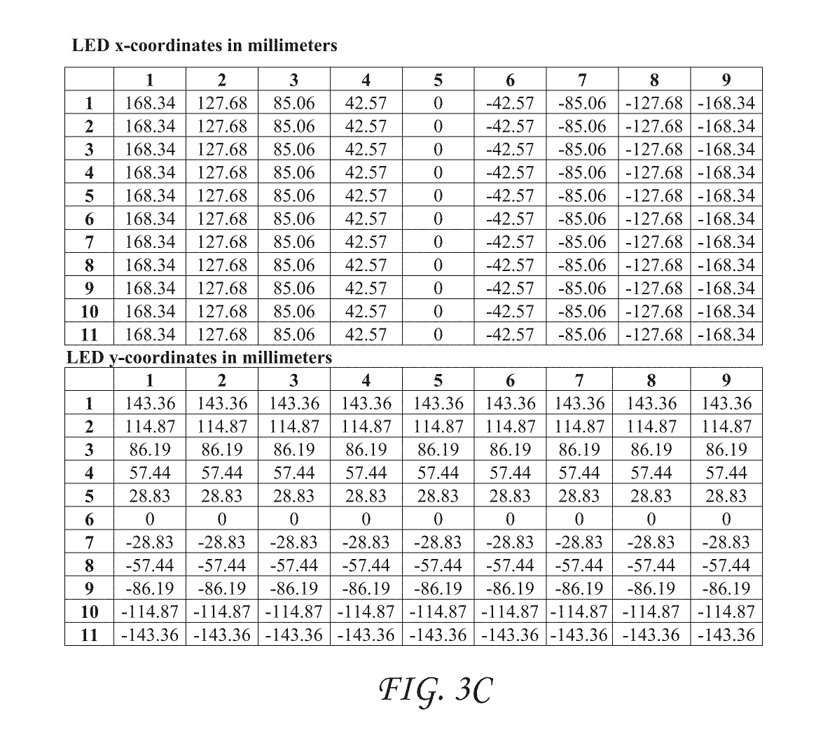

FIG. 3A schematically illustrates a front side 26 of the plurality of optical elements 24 of an example plurality of light sources 20 in accordance with certain embodiments described herein, and FIG. 3B schematically illustrates a back side 28 of the plurality of optical elements 24 of the plurality of light sources 20 of FIG. 3A in accordance with certain embodiments described herein. The lamp 10 can comprise 99 light sources 20, each having an LED 22 with a flux of 586 lm and an optical element 24 (e.g., lens) comprising polycarbonate (e.g., having dimensions of 371 millimeters by 308 millimeters by 16 millimeters). In certain embodiments, the plurality of optical elements 24 can be integral with one another (e.g., formed in a single unitary element), as shown in FIGS. 3A and 3B, while in certain other embodiments, two or more of the optical elements 24 of the plurality of optical elements 24 can be separate from one another. In certain embodiments in which the plurality of optical elements 24 are integral with one another, the plurality of LEDs 22 can positioned on one or more printed circuit boards that are positioned at the back side 28 of the plurality of optical elements 24.

In certain embodiments, as schematically illustrated by FIGS. 1A, 1B, and 3A, the plurality of optical elements 24 are arranged in a substantially planar and substantially rectilinear array with the optical elements 24 arranged in substantially parallel linear rows each extending along a first direction (e.g., the X-direction) and substantially parallel linear columns each extending along a second direction (e.g., the Y-direction) substantially perpendicular to the first direction. For example, the example lamp 10 of FIGS. 1A and 1B comprises 84 optical elements 24 arranged in an array of 12 rows substantially parallel to the X-direction and 7 columns substantially parallel to the Y-direction, and the example lamp 10 of FIG. 3A comprises 99 light sources 20 with the plurality of optical elements 24 arranged in an array of 11 rows substantially parallel to the X-direction and 9 columns substantially parallel to the Y-direction. Other arrays compatible with certain embodiments described herein can have more optical elements, fewer optical elements, more rows, fewer rows, more columns, or fewer columns In addition, the plurality of optical elements 24 schematically illustrated by FIGS. 1A, 1B, and 3A is substantially symmetric about an axis parallel to the X-direction and is substantially symmetric about an axis parallel to the Y-direction. Other array configurations (e.g., non-planar; curved; non-rectilinear; polar; irregular; non-symmetric about at least one axis parallel to the X-direction and/or the Y-direction) are also compatible with certain embodiments described herein.

In certain embodiments, neighboring rows of the optical elements 24 are substantially equally spaced from one another along the second direction (e.g., Y-direction) and neighboring columns of the optical elements 24 are substantially equally spaced from one another along the first direction (e.g., X-direction). In certain other embodiments, the neighboring rows of optical elements 24 across the lamp 10 are not substantially equally spaced from one another and/or the neighboring columns of optical elements 24 across the lamp 10 are not substantially equally spaced from one another. For example, the spacings along the Y-direction between neighboring rows (extending along the X-direction) of optical elements 24 can be adjusted such that a uniformity of the illuminance of the planar region 30 is optimized (e.g., maximized) and/or the spacings along the X-direction between neighboring columns (extending along the Y-direction) of optical elements 24 can be adjusted across the lamp 10 such that a uniformity of the illuminance of the planar region 30 is optimized (e.g., maximized). In certain other embodiments (e.g., polar arrays; irregular arrays), the spacings between neighboring optical elements 24 can be adjusted such that a uniformity of the illuminance of the planar region 30 is optimized (e.g., maximized). In certain embodiments, the spacings between adjacent optical elements 24 can be adjusted to account for manufacturing variations of the light source 20 while still achieving a substantially uniform illuminance across the planar region 30.

In certain embodiments, the neighboring rows of the optical elements 24 are substantially equally spaced from one another along the Y-direction and the neighboring columns of the optical elements 24 are substantially equally spaced from one another along the X-direction, while the positions of the LEDs 22 of these sources 20 relative to positions of the corresponding optical elements 24 differ across the planar array and are configured (e.g., selected; adjusted) to optimize (e.g., maximize) the uniformity of the illuminance by the lamp 10 of the planar region 30 substantially parallel to the planar array.

For example, at least some of the LEDs 22 can be laterally displaced from center positions of the corresponding optical elements 24 in directions parallel to the planar array. FIG. 3B schematically illustrates an example lamp 10 in which the planar array comprises light sources 20 in a plurality of parallel linear rows and a plurality of parallel linear columns perpendicular to the linear rows. The centers of the optical elements 24 of neighboring linear rows (extending along the X-direction) can be equally spaced from one another while the positions of the LEDs 22 (e.g., centers indicated by dots in FIG. 3B) of at least some of the neighboring linear rows are not substantially equally spaced from one another. The centers of the optical elements 24 of neighboring linear columns (extending along the Y-direction) can be equally spaced from one another while the positions of the LEDs 22 of at least some of the neighboring linear columns are not substantially equally spaced from one another. The differences between the centers of the optical elements 24 and the centers of the corresponding LEDs 22 are not to scale in FIG. 3B.

FIG. 3C shows the x- and y-coordinates (in millimeters) of the LEDs 22 for an example plurality of light sources 20 in accordance with certain embodiments described herein. In certain embodiments, the spacings along the X-direction between neighboring columns of LEDs 22 can be adjusted across the lamp 10 such that a uniformity of the illuminance of the planar region 30 is optimized (e.g., maximized) and/or the spacings along the Y-direction between neighboring rows of LEDs 22 can be adjusted across the lamp 10 such that a uniformity of the illuminance of the planar region 30 is optimized (e.g., maximized). As shown in FIG. 3C, the x-coordinates of the LEDs 22 for the columns on one side of the center line (e.g., column 5) are equal in magnitude but opposite in direction from those of the columns that are the same distance from the center line on the other side of the center line, and the y-coordinates of the LEDs 22 for the rows on one side of the center line (e.g., row 6) are equal in magnitude but opposite in direction from those of the rows that are the same distance from the center line on the other side of the center line.

In certain embodiments, the offset (e.g., parallel to the planar array) between a center of the LED 22 and a center of the corresponding optical element 24 of a light source 20 in a first region of the planar array is different from the offset (e.g., parallel to the planar array) of another light source 20 in a second region of the planar array. For example, each light source 20 of the planar array can have a unique offset in a plane parallel to the planar array, the unique offset between a center of the LED 22 and a center of the optical element 24. As shown in FIG. 3C, each of the LEDs 22 has a center with an x-coordinate and a y-coordinate. The centers of the optical elements 24 are positioned on a uniform rectangular array with the same distances between neighboring rows and the same distances between neighboring columns. Each of the centers of the LEDs 22 has a corresponding offset relative to a center of the corresponding optical element 24, such that each LED 22 has a unique offset in the plane parallel to the planar array from the center of the corresponding optical element 24 that differs from those of the other LEDs 22 in magnitude, in direction, or in both magnitude and direction.

In the example configuration of FIGS. 3B and 3C, the planar array comprises a first plurality of parallel lines and a second plurality of parallel lines perpendicular to the first plurality of parallel lines, the optical elements 24 of the first plurality of lines are equally spaced from one another in a first direction perpendicular to the first plurality of lines, and the optical elements 24 of the second plurality of lines are equally spaced from one another in a second direction perpendicular to the second plurality of lines. Also, the LEDs 22 of the first plurality of lines are not equally spaced from one another in the first direction and the LEDs 22 of the second plurality of lines are not equally spaced from one another in the second direction. In certain other embodiments (e.g., polar arrays; irregular arrays), the spacings between neighboring LEDs 22 can be adjusted such that a uniformity of the illuminance of the planar region 30 is optimized (e.g., maximized). In certain embodiments, the spacings between neighboring LEDs 22 can be adjusted to account for manufacturing variations of the light source 20 while still achieving a substantially uniform illuminance across the planar region 30.

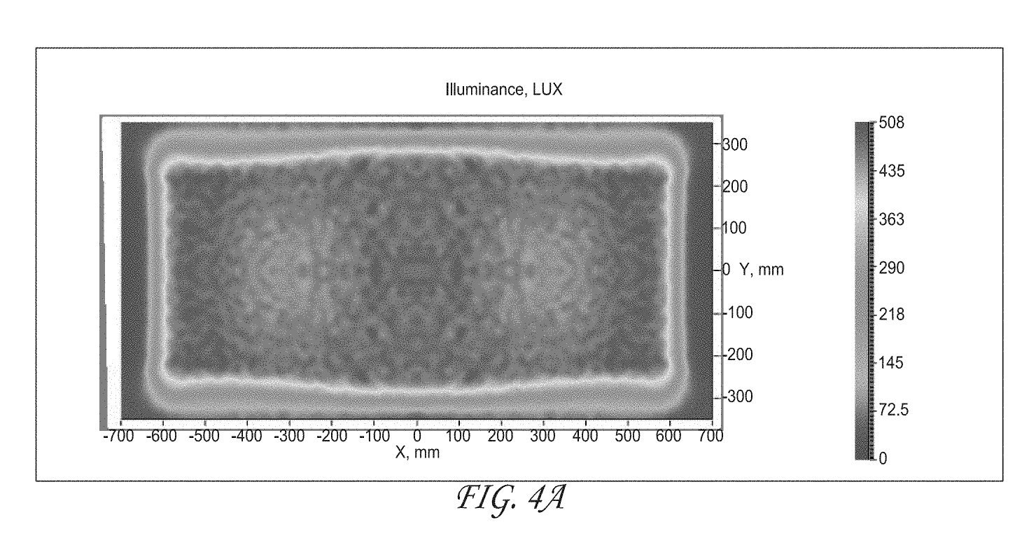

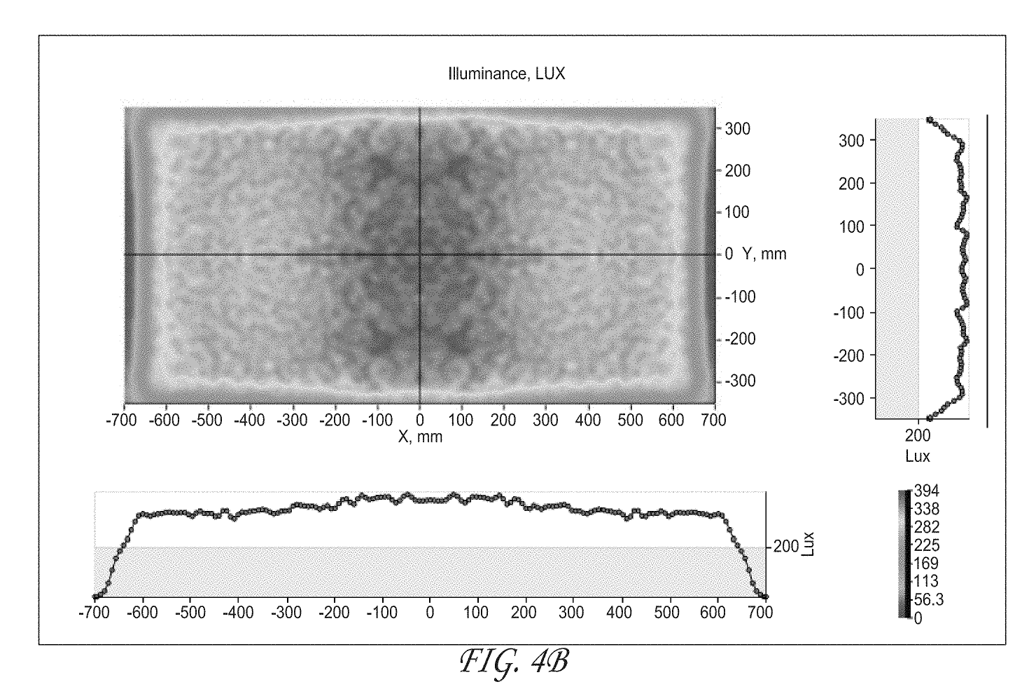

FIG. 4A illustrates an example illuminance across a planar region 30 calculated for the example light source 20 of FIGS. 2A-2B in accordance with certain embodiments described herein. FIG. 4B illustrates an example illuminance across a planar region 30 calculated for the example light source 20 of FIGS. 2C-2D in accordance with certain embodiments described herein. The example illuminances of FIGS. 4A and 4B are calculated to be substantially uniform across the planar region 30.

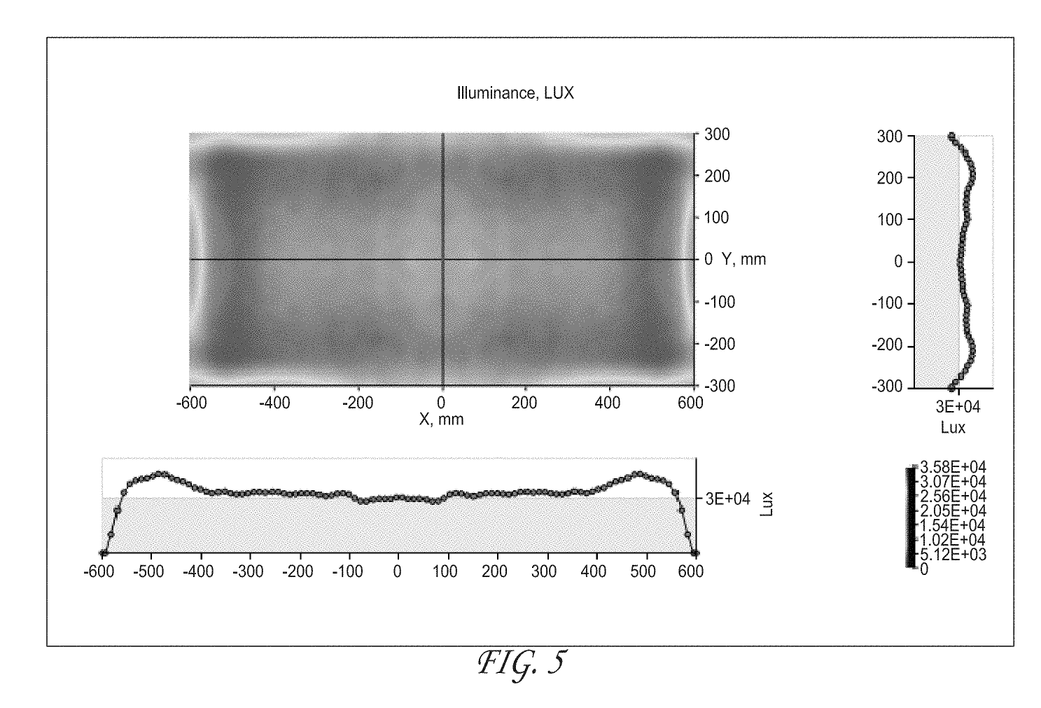

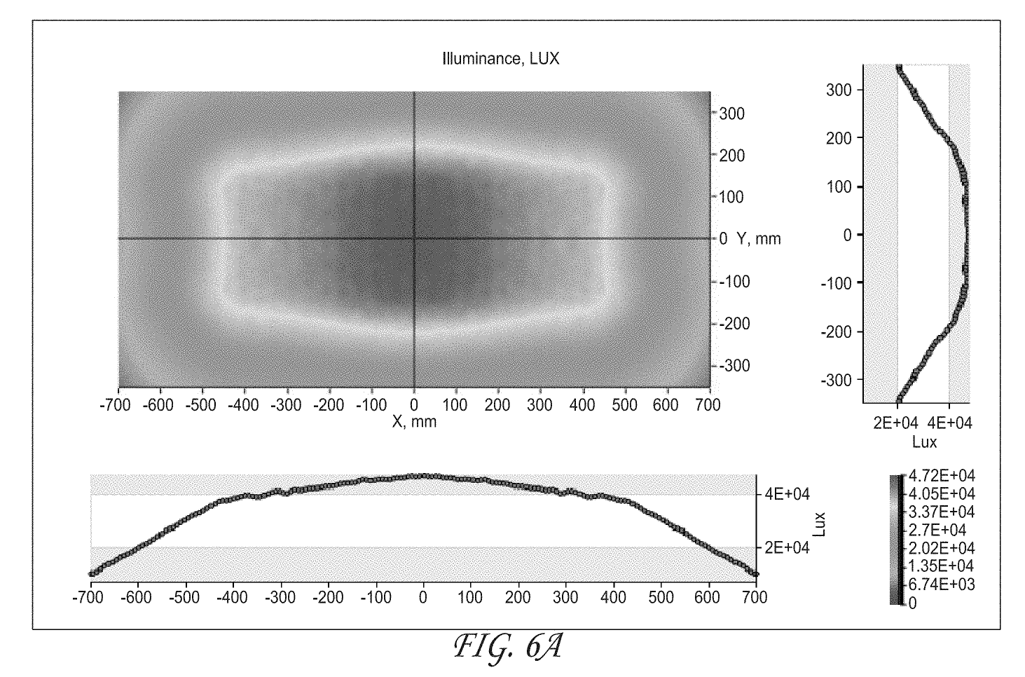

FIG. 5 illustrates an example illuminance across a planar region 30 calculated for the example lamp 10 of FIGS. 1A and 1B using the example light source 20 of FIGS. 2A-2B and with a distance of 300 millimeters between the lamp 10 and the planar region 30 in accordance with certain embodiments described herein. The light from the plurality of light sources 20 is calculated to illuminate the planar region 30 with a substantially uniform illuminance having an average illuminance of about 32,000 lux and having an efficiency of 64%. As used herein, efficiency can be quantified as the ratio of the flux irradiating the planar region 30 divided by the total flux emitted by the lamp 10 (e.g., Φ_{target planar area}/Φₗₐₘₚ). To increase the illuminance, the lamp 10 can comprise more light sources 20.

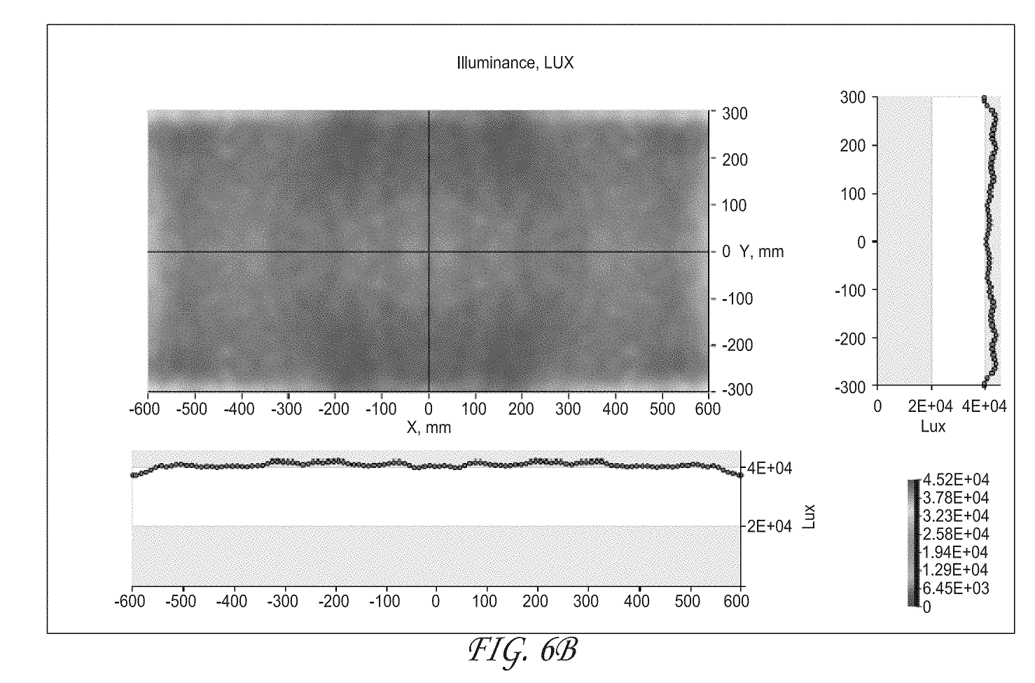

FIG. 6A illustrates an example illuminance across the planar region 30 calculated for the example lamp 10 of FIG. 3A using the example light source 20 of FIGS. 2C and 2D with uniformly spaced LEDs 22 and a distance of 300 millimeters between the lamp 10 and the planar region 30. The light sources 20 are substantially identical to one another, with the neighboring rows of the optical elements 24 substantially equally spaced from one another along the Y-direction, the neighboring columns of the optical elements 24 substantially equally spaced from one another along the X-direction, the neighboring rows of the LEDs 22 substantially equally spaced from one another along the Y-direction, and the neighboring columns of the LEDs 22 substantially equally spaced from one another along the X-direction, with the LEDs 22 positioned at the back side 28 at the center of the first portions 40 of the light sources 20. The calculated illuminance shown in FIG. 6A is not substantially uniform across the planar region 30, due to the overlapping light at the planar region 30 from the plurality of light sources 20.

FIG. 6B illustrates an example illuminance across the planar region 30 calculated for the example lamp 10 of FIG. 3A and 3B with non-uniformly spaced LEDs 22 in accordance with certain embodiments described herein. The illuminance of FIG. 6B was calculated using the example light source 20 of FIGS. 2C and 2D with a distance of 300 millimeters between the lamp 10 and the planar region 30. The neighboring rows of the optical elements 24 are substantially equally spaced from one another along the Y-direction, and the neighboring columns of the optical elements 24 are substantially equally spaced from one another along the X-direction. However, the spacings along the Y-direction between neighboring rows of LEDs 22 are adjusted across the lamp 10 and the spacings along the X-direction between neighboring columns of LEDs 22 are adjusted across the lamp 10 (e.g., with the x- and y-coordinates of the LEDs 22 shown in FIG. 3C) such that a uniformity of the calculated illuminance of the planar region 30 is optimized (e.g., maximized). The calculated illuminance shown in FIG. 6B is substantially uniform across the planar region 30, with an efficiency of 51.4%. In FIG. 6B, the average illuminance is 41445 lux, the minimum illuminance is 34453 lux, and the maximum illuminance is 45160 lux, resulting in a min/max uniformity of 76.3% (Iₘᵢₙ/Iₘₐₓ=0.763) and a min/average uniformity of 83.1% (Iₘᵢₙ/Iₐᵥₑ=0.831). A comparison of the calculated illuminance of FIG. 6A and the calculated illuminance of FIG. 6B shows that adjusting the positions of the LEDs 22 can advantageously produce an improvement in the uniformity of the illuminance across the planar region 30.

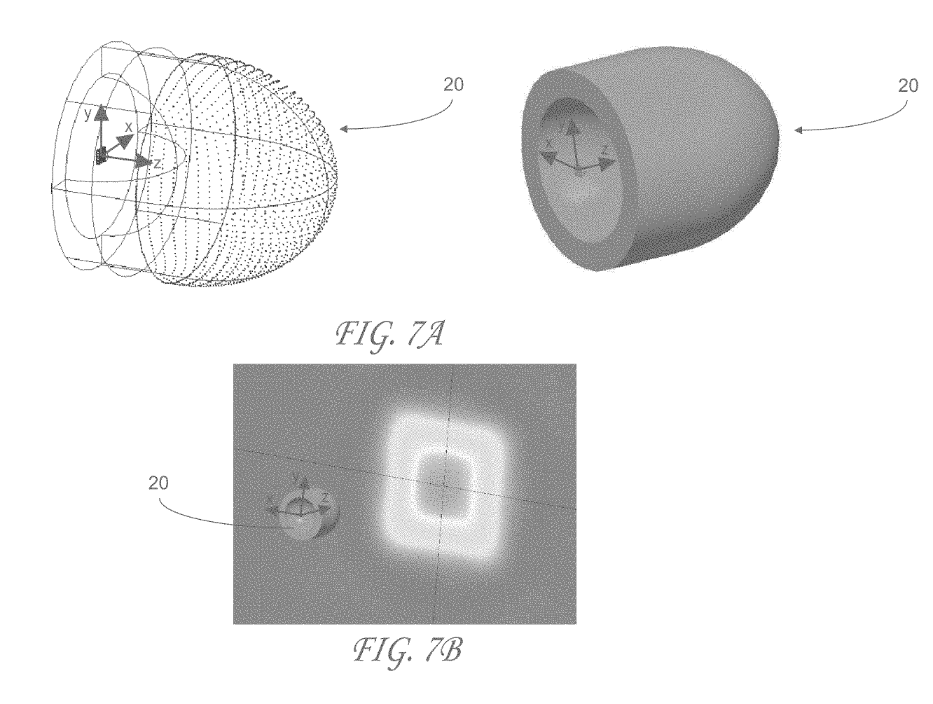

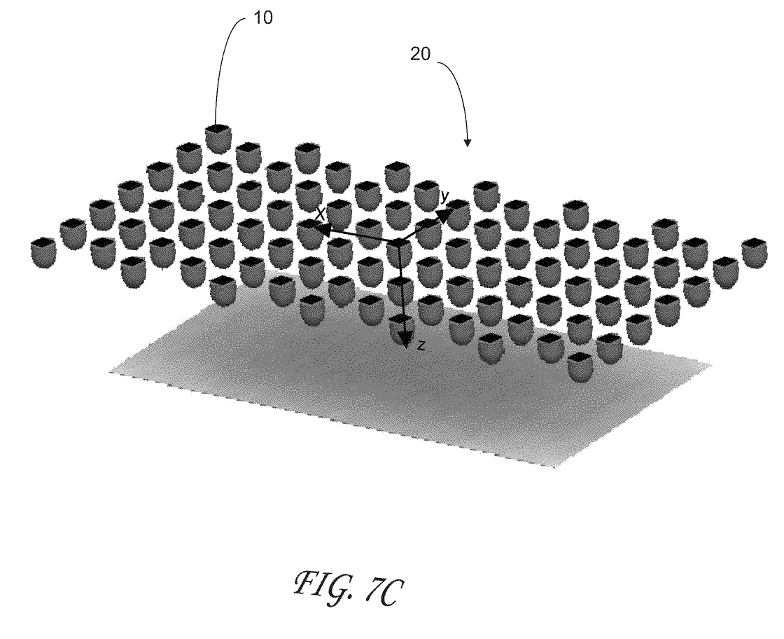

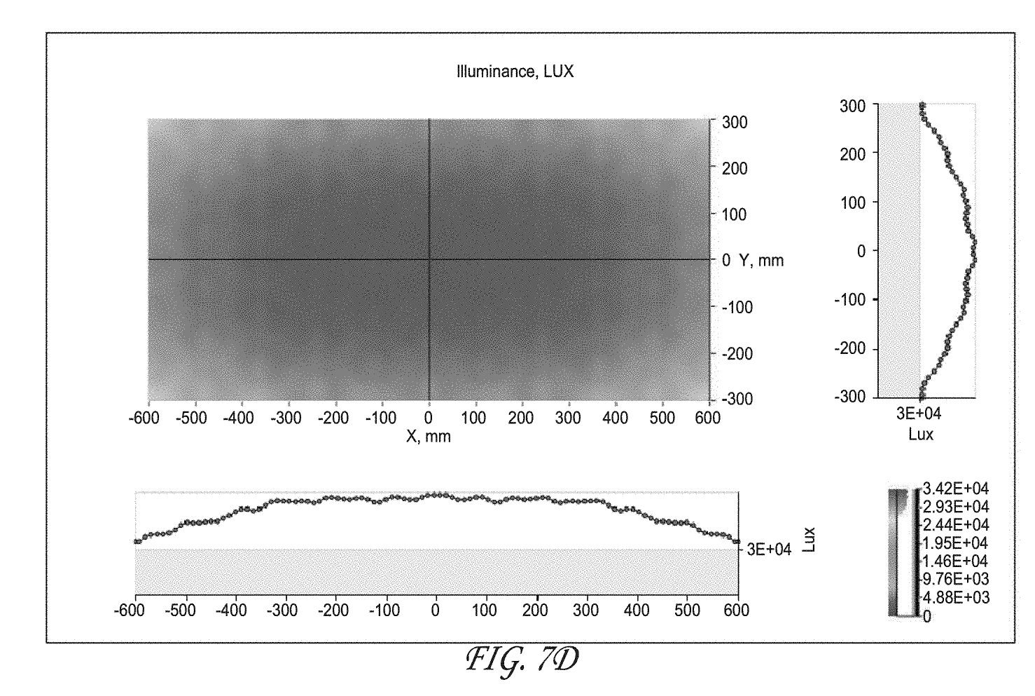

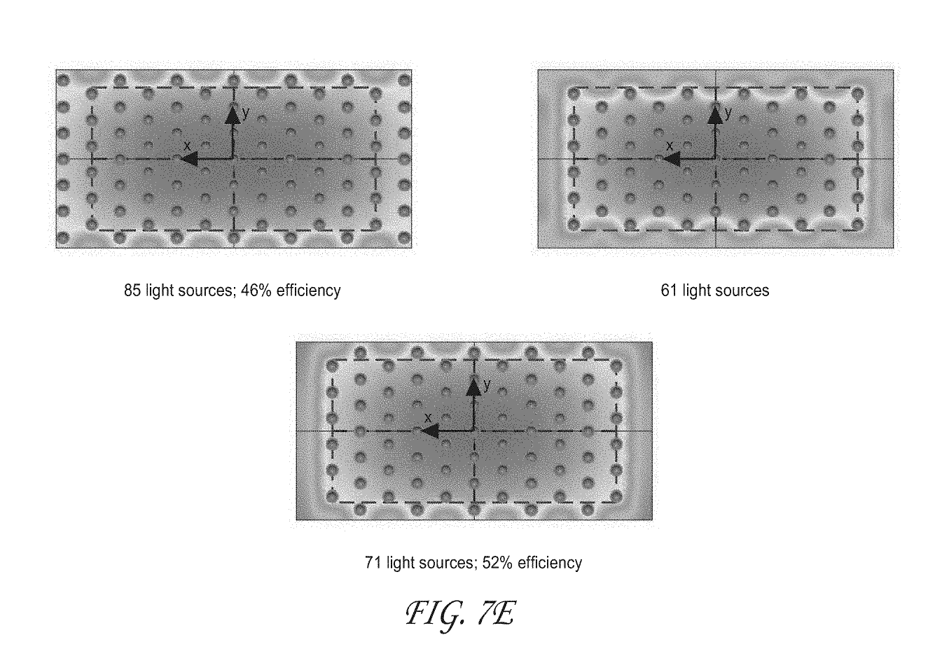

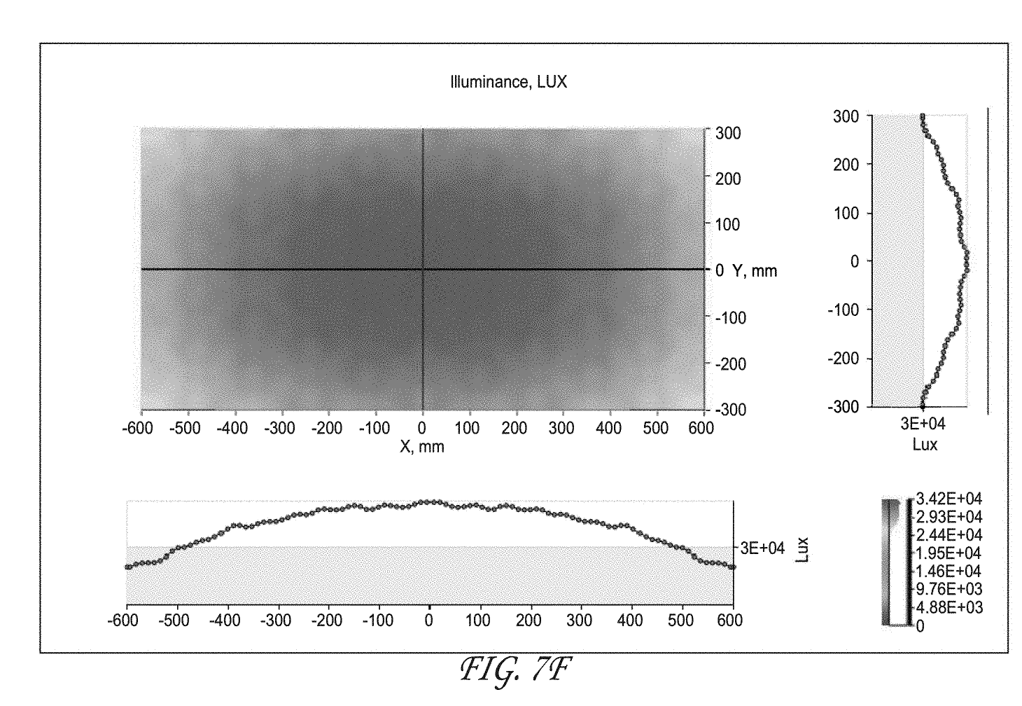

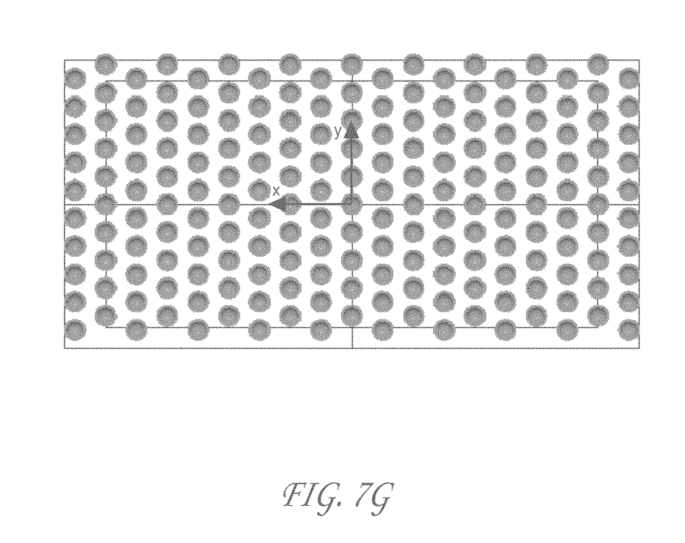

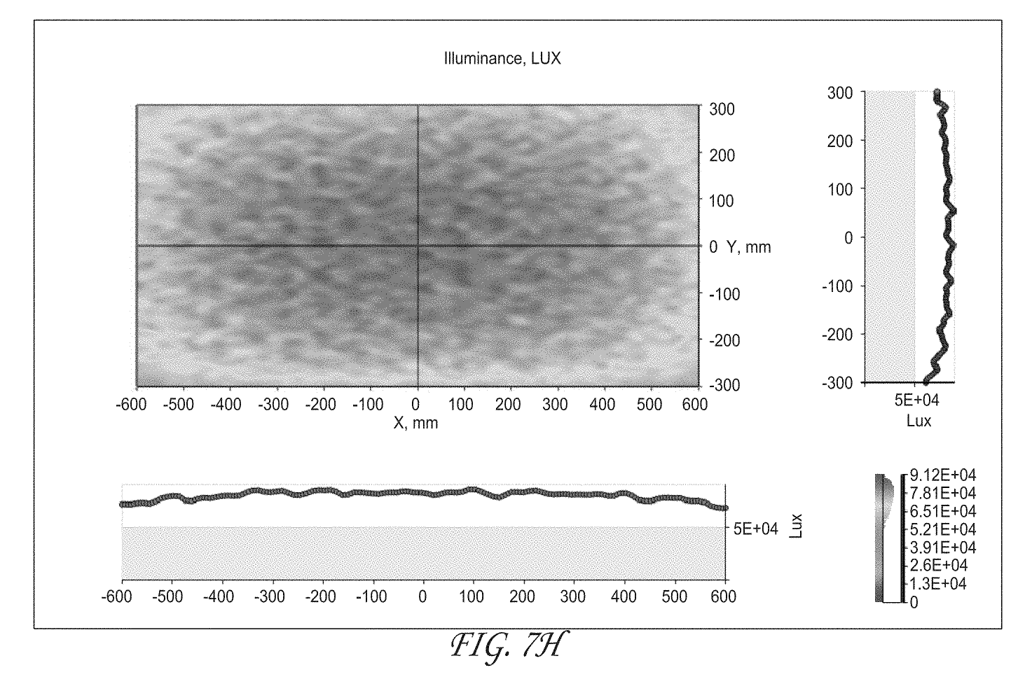

FIGS. 7A-7H schematically illustrate various example lamp configurations using single-lobe light sources 20 in accordance with certain embodiments described herein. In certain embodiments, the configurations use multiple identical light sources 20 with each light source 20 irradiating a corresponding portion (e.g., tile) of the planar region 30. FIG. 7A illustrates a wireframe view and a solid surface view of a single-lobe light source 20 of an example lamp 10, the single-lobe light source 20 comprising PMMA (e.g., having dimensions of 55 millimeters by 60 millimeters). FIG. 7B illustrates an illuminance of the single-lobe light source 20 of FIG. 7A within an area of 300 millimeters by 300 millimeters, and FIG. 7C illustrates an example lamp 10 comprising 85 single-lobe light sources 20 arranged in a rectilinear, two-dimensional array with 7 columns each having 7 light sources 20 (totaling 49 light sources) alternating with 6 columns each having 6 light sources 20 (totaling 36 light sources 20). FIG. 7D illustrates the illuminance calculated to be produced by the example lamp 10 of FIG. 7C. FIG. 7E illustrates the effect of variations of the number of light sources 20 of the example lamp 10 by comparing the illuminances (at a planar region 300 millimeters away) of a lamp 10 with an array of 85 light sources 20, a lamp 10 with an array of 61 light sources 20 (6 columns each having 6 light sources 20 alternating with 5 columns each having 5 light sources 20), and a lamp 10 with an array of 71 light sources 20 (6 columns each having 6 light sources 20 alternating with 5 columns each having 7 light sources 20). FIG. 7F illustrates the illuminance of an example lamp 10 with the array of 71 light sources 20 and shows a relative illumination near the edge of the 1200 millimeter by 600 millimeter planar region 30 to be lower than that of the example lamp 10 with the array of 85 light sources 20 of FIG. 7D. FIGS. 7G and 7H illustrate the effect of reducing the size of the planar region 30 irradiated by one light source 20 and increasing the number of light sources 20 (e.g., to 10 columns each with 10 light sources 20 alternating with 9 columns each with 10 light sources 20, offset from one another by one-half the distance between light sources 20 along the column). The average illuminance of the example lamp 10 shown in FIG. 7G is about 77,210 lux as shown in FIG. 7H. Certain configurations shown by FIGS. 7A-7H can provide easier heat management than the example lamp 10 of FIG. 1B, but do not provide the advantage of an easily modifiable spectral distribution across the entire planar region 30 of certain embodiments described herein.

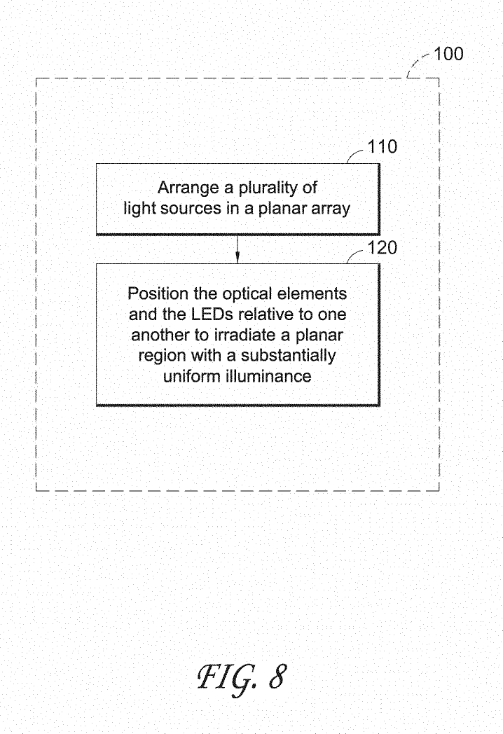

FIG. 8 is a flow diagram of an example method 100 of fabricating a lamp 10 in accordance with certain embodiments described herein. While the method 100 is described by referencing the example structures of FIGS. 1A-1B, 2A-2D, and 3A-3C, the method 100 is compatible with other structures as well. In an operational block 110, the method 100 comprises arranging a plurality of light sources 20 in a planar array. Each light source 20 comprises an optical element 24 and a LED 22. In an operational block 120, the method 100 further comprises positioning the optical elements 24 and the LEDs 22 of the plurality of light sources 20 relative to one another such that light emitted by the LEDs 22 and received by the optical elements 24 is emitted by the optical elements 24 to irradiate a planar region 30 spaced from the planar array by at least 300 millimeters and having dimensions of at least 1200 millimeters by at least 600 millimeters, with the planar region 30 irradiated with an illuminance that is substantially uniform. For example, the illuminance of the planar region 30 can have a uniformity in a range greater than 60% (e.g., where the uniformity is defined as U=Iₘᵢₙ/Iₘₐₓ or U=Iₘᵢₙ/Iₐᵥₑ where Iₘₐₓ is a maximum illuminance across the planar region 30, Iₘᵢₙ is a minimum illuminance across the planar region 30, and Iₐᵥₑ is an average illuminance across the planar region 30. In certain embodiments, each light source 20 of the plurality of light sources 20 is configured to illuminate the entire planar region 30. In certain embodiments, a spectral distribution of the lamp 10 at the planar region 30 is a sum of spectral distributions of the light from the plurality of light sources 20. In certain embodiments, at least some of the LEDs 22 are laterally displaced from center positions of the corresponding optical elements 24 in directions parallel to the planar array.

In the foregoing detailed description, reference is made to the accompanying drawings. The illustrative embodiments described herein are not meant to be limiting. Other embodiments can be utilized, and other changes can be made, without departing from the spirit or scope of the subject matter presented. It will be readily understood that the aspects of the present disclosure and illustrated in the figures, can be arranged, substituted, combined, and designed in a wide variety of different configurations by a person of ordinary skill in the art, all of which are made part of this disclosure.

Reference throughout this disclosure to “one embodiment,” “an embodiment,” or “in certain embodiments” means that a particular feature, structure, or characteristic described in connection with the embodiment is included in at least one embodiment. Moreover, the appearance of these or similar phrases throughout the specification does not necessarily all refer to the same embodiment, nor are separate or alternative embodiments necessarily mutually exclusive. Various features are described herein which can be exhibited by some embodiments and not by others.

Directional terms used herein (e.g., top, bottom, side, up, down, above, below, etc.) are generally used in this disclosure with reference to the orientation shown in the figures and are not intended to be limiting. For example, while some portions of the apparatus may be described as being at the “front side” with other portions of the apparatus being at the “back side,” these terms are intended to provide information regarding the relative positions of these portions to one another and do not imply any absolute orientation with respect to the environment in which the apparatus may be situated.

Unless the context clearly requires otherwise, throughout this disclosure, the words “comprise,” “comprising,” and the like are to be construed in an inclusive sense, as opposed to an exclusive or exhaustive sense; that is to say, in the sense of “including, but not limited to.” The words “coupled” or “connected,” as generally used herein, refer to two or more elements that may be either directly connected, or connected by way of one or more intermediate elements. Where the context permits, words in this disclosure using the singular or plural number may also include the plural or singular number respectively. The word “or,” in reference to a list of two or more items, covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements, and/or states are in any way required for one or more embodiments or that one or more embodiments necessarily include logic for deciding, with or without author input or prompting, whether these features, elements, and/or states are included or are to be performed in any particular embodiment.

As used herein, a phrase referring to “at least one of” a list of items refers to any combination of those items, including single members. As an example, “at least one of” A, B, or C″ is intended to cover: A, B, C, A and B, A and C, B and C, and A and B and C. Conjunctive language such as the phrase “at least one of X, Y, and Z,” unless specifically stated otherwise, is otherwise understood with the context as used in general to convey that an item, term, etc. may be at least one of X, Y, or Z. Thus, such conjunctive language is not generally intended to imply that certain embodiments require at least one of X, at least one of Y, and at least one of Z to each be present.

The above detailed description of embodiments is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

What is claimed is:

1. A lamp comprising:
a plurality of light sources arranged in a planar array, each light source comprising a light-emitting diode (LED) and an optical element, the optical element comprising:
a substantially transparent first portion having a first refractive index, the first portion configured to receive light from the LED; and
a substantially transparent second portion having a second refractive index greater than the first refractive index, the second portion having an emission surface with a two-lobed shape.

2. The lamp of claim 1, wherein the emission surface is substantially symmetric about a first plane, the emission surface having a first cross-section in the first plane, the first cross-section comprising two local maxima and a local minimum between the two local maxima.

3. The lamp of claim 2, wherein the first plane is substantially perpendicular to an emission face of the LED.

4. The lamp of claim 2, wherein the emission surface is substantially symmetric about a second plane perpendicular to the first plane, the emission surface having a second cross-section in the second plane, the second cross-section comprising a single maximum.

5. The lamp of claim 4, wherein the second plane is substantially perpendicular to an emission face of the LED.

6. The lamp of claim 1, wherein the first portion has a shape of a segment of a sphere, the segment defined by an intersection of a third plane with the sphere, and at least a portion of the LED is positioned within the third plane.

7. The lamp of claim 6, wherein the third plane is not at a diameter of the sphere.

8. The lamp of claim 6, wherein the first portion and the second portion are both centered on an axis substantially perpendicular to the third plane.

9. The lamp of claim 1, wherein the first portion comprises a cavity containing a gas and the second portion comprises a solid material.

10. The lamp of claim 1, wherein positions of the LEDs relative to positions of the corresponding optical elements differ across the planar array.

11. The lamp of claim 10, wherein the positions of the LEDs relative to the positions of the corresponding optical elements are configured to optimize a uniformity of the illuminance by the lamp of a planar region substantially parallel to the planar array.

12. The lamp of claim 1, wherein the planar array comprises a plurality of parallel linear rows and a plurality of parallel linear columns perpendicular to the linear rows.

13. The lamp of claim 12, wherein centers of the optical elements of neighboring linear rows are equally spaced from one another and centers of the LEDs of at least some of the neighboring linear rows are not equally spaced from one another.

14. The lamp of claim 13, wherein centers of the optical elements of neighboring linear columns are equally spaced from one another and centers of the LEDs of at least some of the neighboring linear columns are not equally spaced from one another.

15. The lamp of claim 12, wherein each light source of the planar array has a unique offset in a plane parallel to the planar array, the unique offset between a center of the LED and a center of the optical element.

16. The lamp of claim 15, wherein the unique offsets are selected to optimize a uniformity of the illuminance by the lamp of a planar region substantially parallel to the planar array.

17. The lamp of claim 15, wherein each unique offset differs from the other unique offsets by at least one of magnitude and direction in the plane parallel to the planar array.

18. A lamp comprising:
a plurality of light sources arranged in a planar array, each light source comprising a light-emitting diode (LED) and an optical element and having an offset parallel to the planar array, the offset between a center of the LED and a center of the optical element, the offsets in a first region of the planar array different from the offsets in a second region of the planar array.

19. The lamp of claim 18, wherein the offsets of each of the light sources of the plurality of light sources are different from one another in magnitude, in direction, or in both magnitude and direction.

20. The lamp of claim 18, wherein the planar array comprises a first plurality of parallel lines and a second plurality of parallel lines perpendicular to the first plurality of parallel lines, the optical elements of the first plurality of lines are equally spaced from one another in a first direction perpendicular to the first plurality of lines, the LEDs of the first plurality of lines are not equally spaced from one another in the first direction, the optical elements of the second plurality of lines are equally spaced from one another in a second direction perpendicular to the second plurality of lines, and the LEDs of the second plurality of lines are not equally spaced from one another in the second direction.

21. A method of fabricating a lamp, the method comprising:
arranging a plurality of light sources in a planar array, each light source comprising an optical element and a light-emitting diode (LED); and
positioning the optical elements and the LEDs of the plurality of light sources relative to one another such that light emitted by the LEDs and received by the optical elements is emitted by the optical elements to irradiate a planar region spaced from the planar array by at least 300 millimeters and having dimensions of at least 1200 millimeters by at least 600 millimeters, the planar region irradiated with an illuminance that is substantially uniform.

22. The method of claim 21, wherein each light source of the plurality of light sources is configured to illuminate the entire planar region.

23. The method of claim 21, wherein a spectral distribution of the lamp at the planar region is a sum of spectral distributions of the light from the plurality of light sources.

24. The method of claim 21, wherein the illuminance of the planar region has a uniformity defined as U=Iₘᵢₙ/Iₘₐₓ, where Iₘₐₓ is a maximum illuminance across the planar region, Iₘᵢₙ is a minimum illuminance across the planar region, and the uniformity is in a range greater than 60%.

25. The method of claim 21, wherein the illuminance of the planar region has a uniformity defined as U=Iₘᵢₙ/Iₐᵥₑ, where Iₘᵢₙ is a minimum illuminance across the planar region, Iₐᵥₑ is an average illuminance across the planar region, and the uniformity is in a range greater than 60%.

26. The method of claim 21, wherein at least some of the LEDs are laterally displaced from center positions of the corresponding optical elements in directions parallel to the planar array.
